(19) United States
(12) Patent Application Publication
(10) Pub. No.: US 2007/0009275 A1
(43) Pub. Date: Jan. 11, 2007

(54) Image forming apparatus

(75) Inventor: Tatsuro Yokoyama, Sagamihara (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/471,946

(22) Filed: Jun. 21, 2006

(30) Foreign Application Priority Data
Jun. 24, 2005 (JP) 2005-185185
Dec. 22, 2005 (JP) 2005-369432

(51) Int. Cl. G03G 15/20

(52) U.S. Cl. 399/69

(57) ABSTRACT

This is an image forming apparatus for surely detecting that a recording medium collides with a recording head, regardless of the type and lift-up shape of the recording medium. A recording medium carried out of a recording medium tray by a pair of pick-up rollers is sent to an image recording unit via a pair of registration rollers. A recording medium lift-up detection member constituting a collision detection mechanism detects a recording medium on which a lift-up is formed beyond a predetermined distance and applies pressure with corresponding strength to a force sensor. A threshold is preset according to the type of a recording medium, and the force sensor compares a detection value with the threshold. If the detection output exceeds the threshold, there is a possibility that the relevant recording medium may collide with a recording head and the carrying of the recording medium is stopped.

### CROSS REFERENCE TO RELATED APPLICATION

This application claims the benefits of Japanese Patent Application Nos. 2005-185185, filed Jun. 24, 2005, and 2005-369432, filed Dec. 22, 2005, the contents of which are incorporated by this reference.

### BACKGROUND OF THE INVENTION

1. Field of the Invention

The present invention relates to an image forming apparatus for forming an image on a recording medium by passing the recording medium, such as a piece of recording paper or the like, under a recording head and ejecting ink from the recording head.

2. Description of the Related Art

An image forming apparatus for forming an image on a recording medium by carrying the recording medium by a recording medium carrying mechanism, passing it under a recording head and ejecting ink from the recording head is known. In such an image forming apparatus, the space between a plurality of recording nozzles formed on the recording head and the recording medium must be kept optimal while an image is being formed on the recording medium, in order to form an accurate and correct image on the recording medium.

However, when the recording medium is carried on the carrying mechanism, it is often lift-up and carried above the carrying mechanism for various reasons, which is a problem. For example, the recording medium is lift-up, the space between the recording medium and the recording head cannot be kept optimal and printing quality degrades. In particular, if the recording medium is highly lift-up, the tip of the recording medium collides with the recording head to break the recording nozzle.

As a method for preventing this recording medium from colliding with the recording head, for example, Japanese Patent Application Publication No. S64-45677 discloses one using a collision alarm sensor. This collision alarm sensor is provided with a contact piece extending from the tip of head relatively moving against the recording medium on a platen toward the recording medium. When the space between the tip of the head and the recording medium becomes smaller than a prescribed value, the head is prevented from colliding with the recording medium by making the lift-up part of the recording medium touch the contact piece to issue an alarm.

Japanese Patent Application Publication No. 2001-328246 also discloses a method for preventing this recording medium from colliding with the recording head. Japanese Patent Application Publication No. 2001-328246 discloses a technology for disposing collision alarm sensors across the entire recording width of the image forming apparatus, specifically the entire width of the ink-jet nozzle array of a printing head to detect the lift-up of the recording medium such that may cause collision.

### SUMMARY OF THE INVENTION

The image forming apparatus of the present invention comprises a recording medium carrying mechanism for carrying a recording medium, a recording head for recording an image on the recording medium carried by the recording medium carrying mechanism, a recording medium lift-up sensor disposed in the upper stream of the carrying direction of the recording medium than the recording head and a carrying control unit for controlling the recording medium carrying mechanism, based on the detection output of the recording medium lift-up sensor. The recording medium lift-up sensor comprises a recording medium lift-up detection member for sensing the lift-up part of the recording medium and a force sensor for detecting the amount of force of the recording medium which acts on the recording medium lift-up detection member.

Thus, the recording medium can be prevented from colliding with the recording head, by the recording medium lift-up sensor using the recording medium lift-up detection member and the force sensor.

The force sensor has a plurality of thresholds corresponding to the types, lift-up statuses and the like, of a recording medium, and can optically detect the lift-up of the recording medium by adopting a threshold corresponding to the type, lift-up status and the like of the recording medium.

The image forming apparatus of the present invention also comprises a recording medium carrying mechanism for carrying a recording medium, a recording head fixed on the device main body, for recording an image on the recording medium carried by the recording medium carrying mechanism, a recording medium lift-up sensor disposed in the upper stream of the carrying direction of the recording medium than the recording head and a carrying control unit for controlling to carry the recording medium carrying mechanism, based on the detection output of the recording medium lift-up sensor. The recording medium lift-up sensor comprises a swing piece for sensing the lift-up part of the recording medium and an angle sensor for detecting the amount of swing of the swing piece.

Thus, the recording medium can be prevented fro colliding with the recording head by the recording medium lift-up sensor using the swing piece and the angle sensor.

The image forming apparatus of the present invention also comprises a recording medium carrying mechanism for carrying a recording medium, a recording head fixed on the device main body, for recording an image on the recording medium carried by the recording medium carrying mechanism and a collision alarm sensor disposed in the upper stream of the carrying direction of the recording medium than the recording head. The collision alarm sensor comprises a recording medium lift-up detection member for sensing the lift-up part of the recording medium and a detection sensor for detecting the status change of the recording medium lift-up detection member. The recording medium lift-up detection member is structured in such a way as to extend perpendicular to the carrying direction of the recording medium and also in the width direction of the recording medium and to have at least two values in the width direction as sensitivity for sensing the lift-up of the recording medium.

The recording head can be, for example, an ink-jet head. For example, a plurality of the detection sensors can also be provided.

In this image forming apparatus, the recording medium lift-up detection member is formed, for example, in such a way as to have at least two values as space with the recording medium. In this case, for example, the recording medium lift-up detection member is structured in such a way that its space with the recording medium at the center of the width direction may be narrower than its space with the recording medium at the end of the width direction.

In this image forming apparatus, the recording medium lift-up detection member can also be divided into a plurality of members. In this case, it has at least two values as its space with the recording medium. Alternatively, it can have at least two values as the detection sensitivity of the recording medium. Alternatively, it can at least two values as the detection limit widths of the recording medium.

### BRIEF DESCRIPTION OF THE DRAWINGS

FIG. 1 is the rough side view of the image forming apparatus in one aspect of the present invention;

FIG. 2 is the rough top view of a platen unit;

FIG. 3A is the angular perspective of a collision detection mechanism used in the first preferred embodiment;

FIG. 3B is its rough side view;

FIG. 4A is the angular perspective of a collision detection mechanism used in the second preferred embodiment;

FIG. 4B is its rough side view;

FIG. 5A is the angular perspective of a collision detection mechanism used in the third preferred embodiment;

FIG. 5B is its rough side view;

FIG. 6 is the angular perspective of a collision detection mechanism used in the fourth preferred embodiment;

FIG. 7 is the typical side view of the major part of the image forming apparatus in the fifth preferred embodiment;

FIG. 8 is the detailed angular perspective of a collision detection mechanism used in the fifth preferred embodiment;

FIGS. 9A, 9B and 9c show various typical shapes of a recording medium which cause the recording medium to lift-up above a platen belt;

FIGS. 10A and 10B show the detailed shape of the recording medium lift-up detection member in the first preferred embodiment of the collision detection mechanism;

FIG. 11 shows the detailed shapes of the recording medium lift-up detection member in the second and fourth preferred embodiments of the collision detection mechanism; and

FIGS. 12A, 12B and 12c show the detailed shape of the recording medium lift-up detection member in the third preferred embodiment of the collision detection mechanism and its operation.

### DESCRIPTION OF THE PREFERRED EMBODIMENTS

The preferred embodiments of the present invention are described below with reference to the drawings.

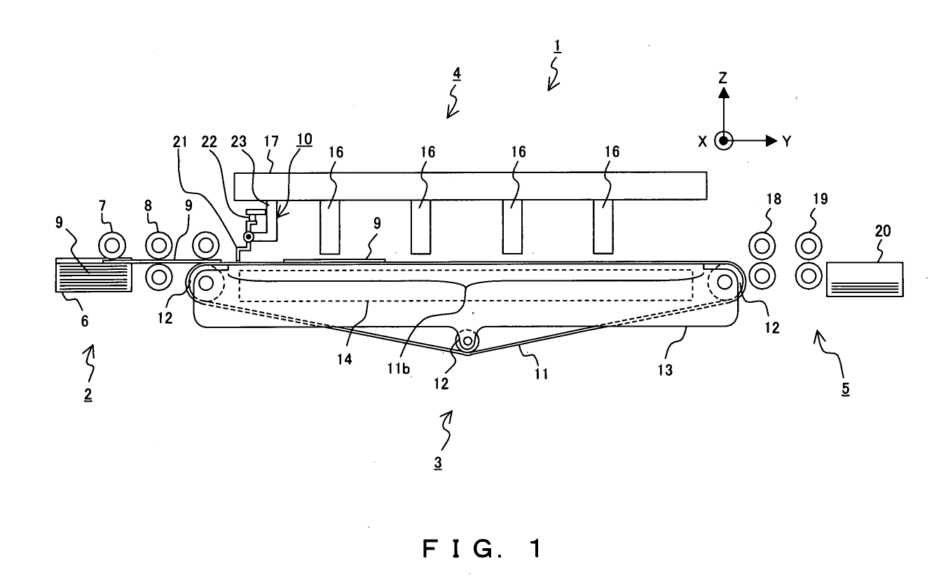

FIG. 1 is the rough side view of the image forming apparatus in one aspect of the present invention. This preferred embodiment uses an ink-jet printer 1 as the image forming apparatus. The ink-jet printer 1 comprises a paper feeding unit 2, a platen unit 3, an image recording unit 4, a discharge unit 5 and a collision detection mechanism 10. In this specification it is assumed that an axis along the recording medium carrying direction is the Y-axis, an axis orthogonal to the Y-axis on a plane where an image is formed on a recording medium at the time of image formation is the X-axis and an axis orthogonal to the X-axis and Y-axis is the Z-axis.

Firstly, the paper feeding unit 2 is described. The paper feeding unit 2 comprises a paper tray 6, a pick-up roller 7 and a pair of registration rollers 8. The paper tray 6 accommodates at least one recording medium (paper). In this preferred embodiment, this paper tray 6 accommodates a plurality of pieces of cut-sheet paper.

The pick-up roller 7 picks up the top one of the recording medium 9 accommodated in the paper tray 6 one piece by one piece. The pick-up roller 7 is supported by a device frame, which is not shown in FIG. 1, in such a way as to rotate.

The pair of registration rollers 8 align a recording medium 9 carried by the pick-up roller 7 to the carrying direction. This pair of registration rollers 8 is also supported by a device frame, which is not shown in FIG. 1, in such a way to rotate. This pair of registration rollers 8 also carries the aligned recording medium 9 to the platen unit 3 side.

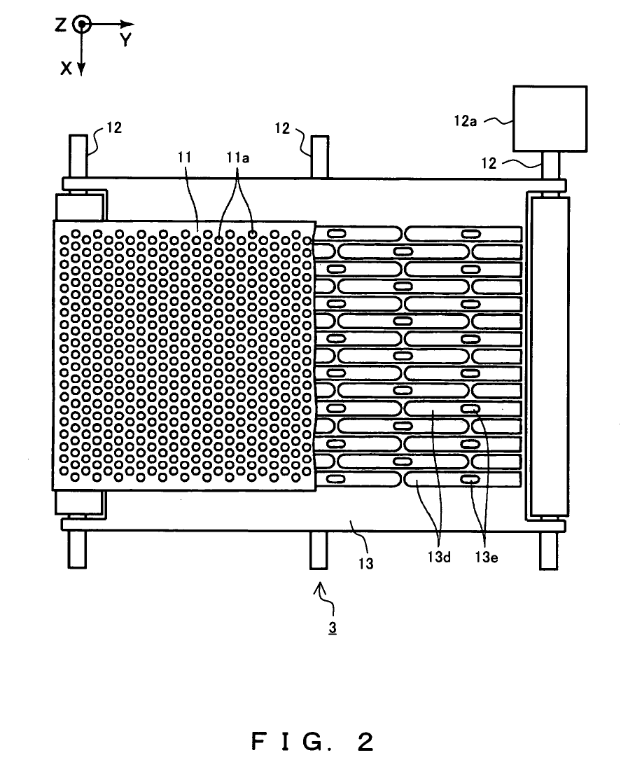

Next, the platen unit 3 is described. The platen unit 3 carries the recording medium 9 fed from the paper feeding unit 2 at the time of image recording. AS shown in FIG. 1, this platen unit 3 comprises a platen belt 11, a plurality of platen belt rollers 12, a platen frame 13 and a platen absorption unit 14. FIG. 2 is the rough top view of the platen unit.

The platen belt 11 and the plurality of platen belt rollers 12 constitute a belt conveyer for co-operating to carry a recording medium 9 along the Y-axis. The belt conveyer sets the carrying direction of a recording medium 9 at the time of recording. In FIG. 2, only almost its half in the Y-axis is shown for the description purpose.

The plurality of platen belt rollers 12 supports the platen belt 11 in such a way that the platen belt 11 may become in parallel with the X- and Y-axes in a platen paper carrying area 11b where the platen belt 11 and the image recording unit are opposed to each other. To at least one of the platen belt rollers 12, a belt roller driving motor 12a for rotating the platen belt rollers 12 is connected.

The platen belt 11 is provided with a plurality of absorption holes 11a disposed across it. A platen frame 13 for flatly supporting the platen belt is provided below the platen belt 11. This platen frame 13 supports the platen belt rollers 12 in such a way as to rotate and also holds the platen absorption unit 14.

This platen frame 13 has surfaces along the X- and Y-axes, and a plurality of groves 13d which extends in the Y-axis direction across the entire area opposing the platen belt 11. At almost the center of each groove 13d, an absorption hole 13e is formed through a platen chamber, which is not shown in FIG. 2.

The platen absorption unit 14 generates negative pressure for absorbing the recording medium 9. This platen absorption unit 14 is fixed on the platen frame 13. This platen absorption unit 14 is provided with a platen chamber, which has a negative pressure generation source for putting the chamber in negative pressure. For this negative pressure generation source, a known negative pressure generation means, such as a fan or the like is used. Thus, the platen chamber absorbs the air from the absorption hole 13e by the negative pressure of the negative pressure generation source and absorbs the recording medium 9 being carried via the platen belt 11.

Next, the image recording unit 4 is described. The image recording unit 4 ejects ink on the recording medium 9. This image recording unit 4 comprises a plurality of recording heads 16 and a carriage 17.

The recording head 16 is an aggregate of image recording heads for recording an image. This recording head 16 is provided in accordance with each color of for example, magenta (M), cyan (C), yellow (Y) and black (K) across the same as or longer than the maximum width of a recording medium to be used. For example, if the ink-jet printer 1 in this preferred embodiment corresponds to an A3-size recording medium, the width of each recording head 16 is formed over an A3-size recording medium width. These recording heads 16 are supported by the carriage 17 to constitute a fixed line head.

Next, the discharge unit 5 is described. The discharge unit 5 discharges a recording medium 9 on which the image recording unit 4 forms an image outside the device. As shown in FIG. 1, the discharge unit 5 comprises a pair of discharge unit carrying rollers 18, a pair of discharge unit discharge rollers 19 and a paper discharge tray 20.

The pair of discharge unit carrying rollers 18 carries a recording medium 9 carried from the platen unit 3 side to the pair of discharge unit discharge rollers 19. The pair of discharge unit discharge rollers 19 the recording medium 9 carried from the discharge unit carrying rollers 18 to the discharge tray 20. Then, every time a recording medium 9 on which an image is formed is discharged from the pair of discharge unit discharge rollers 19, the recording medium 9 is piled in the paper discharge tray 20.

Next, the collision detection mechanism 10 is described. The collision detection mechanism 10 is provided between the paper feeding unit 2 and the image recording unit 4 and is disposed on the upper stream side of the recording medium carrying direction of the recording head 16. The collision detection mechanism 10 detects collision before a recording medium 9 which is anticipated to collide with the recording head 16 is carried under the recording head 16. Specifically, when the collision detection mechanism 10 detects it, a signal is transmitted to a platen unit drive/control mechanism, which is not shown in FIG. 2, for example, to stop the drive of a belt roller driving motor 12a. Thus, the recording medium 9 is prevented from colliding with the recording head 16.

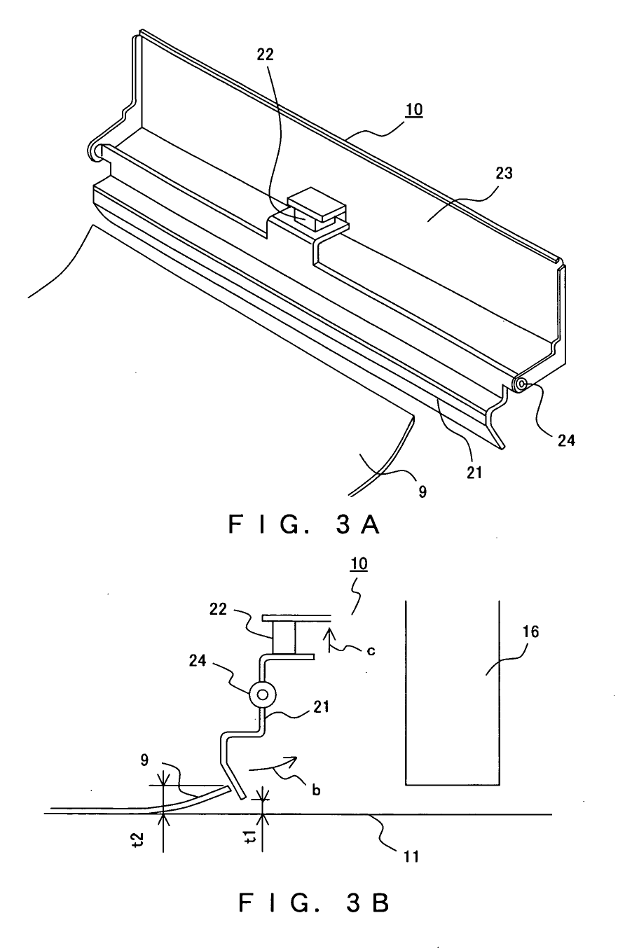

FIGS. 3A and 3B show the detailed collision detection mechanism 10. FIG. 3A is the angular perspective of the collision detection mechanism 10 and FIG. 3B is its rough side view. The collision detection mechanism 10 comprises a recording medium lift-up detection member (hereinafter simply called “lift-up detection member”) 21 for detecting the lift-up of a recording medium 9, a force sensor 22 for measuring the amount of force caused when the recording medium 9 touches the lift-up detection member 21 and a holding member 23 for holding these units.

For the force sensor 22, a distortion gauge, a semiconductor pressure sensor or the like is used. This preferred embodiment uses a semiconductor pressure sensor. As shown in FIGS. 3A and 3B, the float detection member 21 performs a pendulum movement with a rotation shaft 24 as the center, and applies pressure to the force sensor 22 from bottom to top. The force sensor 22 specifies the pressure applied to it in this status as an initial value and subtract the initial value from pressure applied to the force sensor 22 when the recording medium 9 collides with the recording head from the initial value. Thus, the force sensor 22 outputs a corresponding electric signal.

In this preferred embodiment, a distance t1 between the platen belt 11 and the lift-up detection member 21 at the time of recording is set to a distance where various recording media 9 which may touch the recording head 16 can touch the lift-up detection member 21. The upper limit of this distance t1 is the distance between the recording head 16 and the platen belt 11 and the distance t1 is set equal to or less than the distance.

Thus, when actually printing an image, firstly an operation panel, which is not shown in FIG. 3 is operated to specify a recording medium to be carried. By this specification, the corresponding threshold amount of force is read from a table which is not shown in FIG. 3. Specifically, the threshold amount of force corresponding to the type of the recording medium 9 is registered in the table in advance and a threshold optimal to the recording medium 9 to be used can be read by the specification.

Then, when the printing process is started, as described above, the recording medium 9 is carried out of the paper tray 6 by the pick-up roller 7 and is sent to the image recording unit 4 via the pair of registration rollers 8. In this case, the collision detection mechanism 10 detects the lift-up of the recording medium. In this case, a non-lift-up recording medium and a recording medium with lift-up equal to or less than the distance t1 passes through under the lift-up detection member 21 and is sent to the image recording unit 4. However, if the lift-up at the tip of the recording medium 9 exceeds the distance t1 as shown in FIG. 3, the recording medium 9 collides with the lift-up detection member 21 and pressure is applied to the lift-up detection member 21 in the direction of an arrow “b”. As described above, since the collision detection mechanism 10 performs a pendulum movement with the rotation shaft 24 as the center, the pressure pushes up the force sensor 22 in the direction of an arrow “c” with the rotation shaft 24 as the fulcrum.

As described above, the force sensor 22 outputs pressure obtained by subtracting the initial value from the allied pressure as an electric signal. Therefore, if the pressure corresponding to the electric signal is larger than the threshold amount of force read from the table, it is determined that there is a possibility of the collision and the carrying of the recording medium 9 is stopped.

For example, if it is thick or elastic, when the recording medium 9 touches the lift-up detection member 21, it deforms little. Therefore, the threshold amount of force is set high. If the recording medium 9 is thin and not elastic, when the recording medium 9 touches the lift-up detection member 21, its shape is easy to deform. Therefore, the threshold amount of force is set low.

Thus, detection can be performed in accordance with the thickness and elasticity.

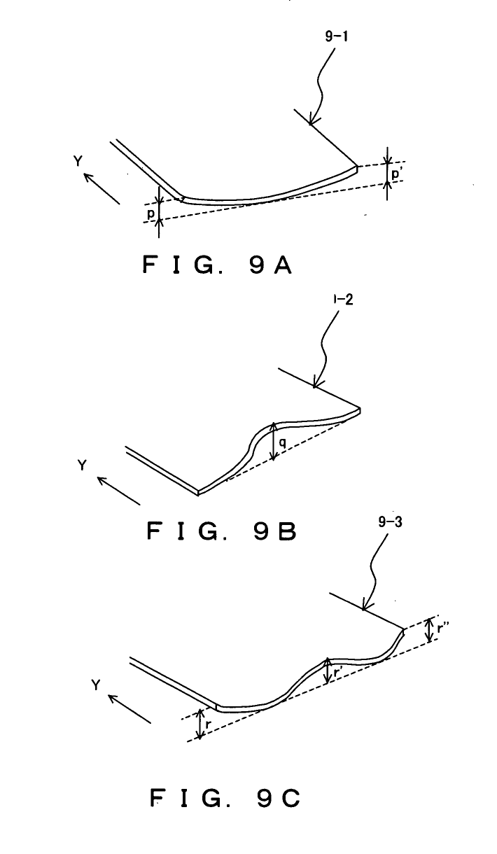

Even when the type of the recording medium 9 is the same, each end of the recording medium 9 is easily absorbed by the platen unit 3 and is fixed, depending on the difference in a lift-up shape, for example, if the center of the recording medium 9 becomes easily concave (see FIG. 9B). Therefore, even when a crush force is applied, a curled shape does not deform easily. Therefore, in this case, the collision is detected by setting the threshold amount of force high. If each bent end and a concave center are combined (see FIG. 9C), the collision is detected after setting the threshold amount of force low.

As described above, in this preferred embodiment, the force sensor 22 is used to detect in advance that the recording medium 9 collides with the recording head 16 and, for example, the carrying of the recording medium 9 is stopped to avoid the damage of the recording head 16 in advance.

In this preferred embodiment, since the part of the lift-up detection member 21 with which the tip of the recording medium 9 collides is angled in the direction where the platen belt 11 leads the recording medium 9 after the recording medium 9 collides with it, the recording medium 9 that has passed through under the lift-up detection member 21 is smoothly absorbed by the platen unit 3 side to reduce the possibility that the recording medium 9 may collide with the recording head 16.

Next, the second preferred embodiment is described.

In the description of the second preferred embodiment, the same reference numerals are attached to the same components as in the first preferred embodiment, and the description of the same function or effect as in the first preferred embodiment is omitted here.

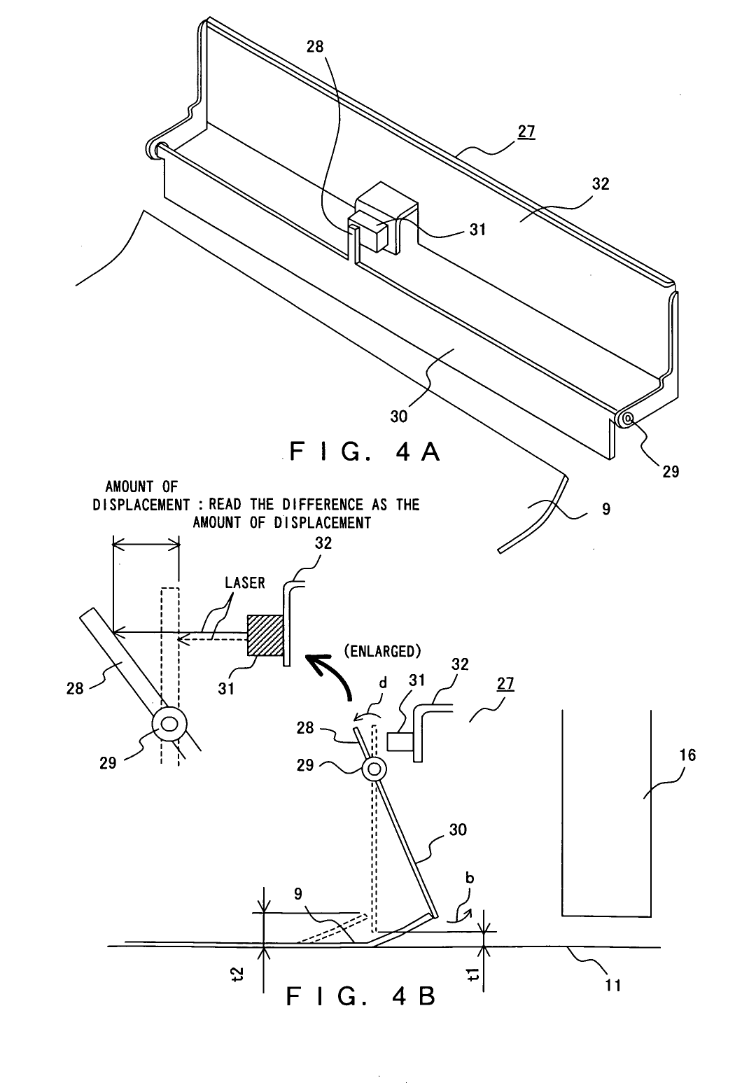

FIGS. 4A and B show the structure of the collision detection mechanism 27 used in this preferred embodiment. FIG. 4A is the angular perspective of the collision detection mechanism 27 and FIG. 4B is its rough side view. The collision detection mechanism 27 comprises a swing piece 28, a lift-up detection member 30 for performing a pendulum movement with the rotation shaft 29 as the center, an angle sensor 31 for measuring a rotation angle at which the lift-up detection member 30 is rotated by the touch of the recording medium 9 and a holding member 32 for holding them.

To measure the rotation angle of the lift-up detection member 30 means to measure the amount of lift-up from the platen belt 11 of the recording medium 9. In this preferred embodiment, for example, for the angle sensor 31, a laser displacement meter is used. The laser displacement meter reads the position of the swing piece 28 initially set in advance and specifies the position as the initial value. The angle sensor 31 measures the amount of movement of the swing piece 28 with the rotation shaft 29 as the center in the case where the recording medium 9 collides with the lift-up detection member 30. Then, the angle sensor 31 converts the amount of movement into a rotation angle and outputs it.

In this preferred embodiment too, a distance t1 between the platen belt 11 and the lift-up detection member 30 at the time of printing is set to a distance where various recording media 9 which may touch the recording head 16 can touch the lift-up detection member 30. The upper limit of this distance t1 is the distance between the recording head 16 and the platen belt 11 and the distance t1 is set equal to or less than the distance.

Thus, when actually printing an image, firstly an operation panel, which is not shown in FIG. 4 is operated to specify a recording medium to be carried. By this specification, the threshold of a corresponding angle is read from a table which is not shown in FIG. 4. Specifically, the threshold of an angle corresponding to the type of the recording medium 9 is registered in the table in advance and a threshold optimal to the recording medium 9 to be used can be read by the specification.

Then, when the printing process is started, as described above, the recording medium 9 is carried out of the paper tray 6 by the pick-up roller 7 and is sent to the image recording unit 4 via the pair of registration rollers 8. In this case, the collision detection mechanism 10 detects the lift-up of the recording medium. In this case, a non-lift-up recording medium and a recording medium with lift-up equal to or less than the distance t1 passes through under the lift-up detection member 21 and is sent to the image recording unit 4. However, if the lift-up at the tip of the recording medium 9 exceeds the distance t1 as shown in FIG. 4, the recording medium 9 collides with the lift-up detection member 30 and pressure is applied to the lift-up detection member 30 in the direction of an arrow “b”. As described above, since the collision detection mechanism 27 performs a pendulum movement with the rotation shaft 29 as the center, the pressure pushes up the swing piece 28 in the direction of an arrow “d” with the rotation shaft 29 as the fulcrum.

As enlarged and shown in FIG. 4B, this amount of displacement is a distance obtained by subtracting the initial value from a distance covered by the movement due to the rotation. This distance is read by the angle sensor 31 and is outputted as an electric signal. Therefore, if the distance corresponding to the electric signal is longer than the threshold read from the table, it is determined that there is the possibility of the collision and the carrying of the recording medium 9 is stopped.

For example, if the recording medium 9 is thick or elastic, when it touches the lift-up detection member 30, it does not deform due to the weight, contact resistance and the like of the lift-up detection member 30 and is easily kept lift-up. Therefore, in this case, the threshold of the angle sensor 30 is set high. If the recording medium 9 is thin or not elastic, when it touches the lift-up detection member 30, it deforms due to the weight, contact resistance and the like of the lift-up detection member 30 and the lift-up shape is crushed. Therefore, the collision is detected in accordance with the thickness and elasticity of the recording medium 9 by setting the threshold of the angle sensor 31 low.

Even when the type of the recording medium 9 is the same, for example, a shape whose center is concave (see FIG. 9B) is strong against weight and a shape, each end of which is bent upward (see FIG. 9A) is weak against weight. If there is only a shape whose center is concave, the threshold of the angle sensor 30 is set high. If there are not only a shape whose center is concave but also a bent shape, the threshold is set low. Thus, according to this preferred embodiment, the collision can be detected according to the lift-up shape of the recording medium 9, thereby preventing the recording medium 9 from colliding with the recording head.

For the angle sensor 30, various sensors can be used. For example, sensors which can detect the rotation angle of the lift-up detection member 30, such as a contact type displacement meter, a rotary encoder and the like, can be used.

Next, the third preferred embodiment of the present invention is described.

In the description of the third preferred embodiment, the same reference numerals are attached to the same components as in the first and second preferred embodiments, and the description of the same function or effect as in the first and second preferred embodiments is omitted here.

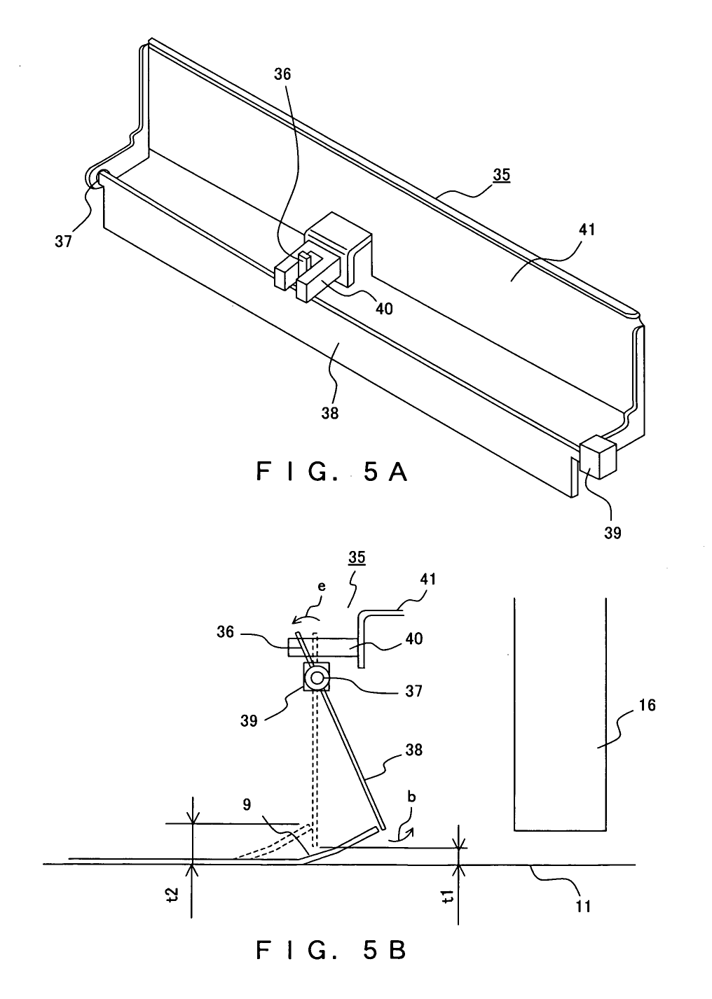

FIGS. 5A and 5B show the structure of the collision detection mechanism 35 of this preferred embodiment. FIG. 5A is the angular perspective of the collision detection mechanism 35 and FIG. 5B is its rough side view. The collision detection mechanism 35 comprises a swing piece 36, a lift-up detection member 38 for performing a pendulum movement with the rotation shaft 37 as the center, a force sensor 39, an angle sensor 40 for measuring the rotation angle caused when the recording medium 9 touches the lift-up detection member 38 and a holding member 41 for holding them. In this preferred embodiment, for the force sensor 39, a rotation torque sensor is used. In this preferred embodiment too, a distance t1 between the platen belt 11 and the lift-up detection member 38 at the time of printing is set to a distance where various recording media 9 which may touch the recording head 16 can touch the lift-up detection member 38. The upper limit of this distance t1 is the distance between the recording head 16 and the platen belt 11 and the distance t1 is set equal to or less than the distance.

This preferred embodiment comprises a table for the threshold of the amount of contact force and a table for the threshold of the amount of angle displacement, and detects collision using both the tables.

Firstly, when the printing process is started, as described above, the recording medium 9 is carried out of the paper tray 6 by the pick-up roller 7, and is sent to the image recording unit 4 via the pair of registration rollers 8. In this case, the collision detection mechanism 35 detects the collision of the recording medium 9. For example, if the lift-up at the tip of the recording medium 9 exceeds the distance t1 as shown in FIGS. 5A and 5B, the recording medium 9 collides with the lift-up detection member 38, and pressure is applied to the lift-up detection member 38 in the direction of an arrow “b”. Then, as described above, the collision detection mechanism 35 performs a pendulum movement with the rotation shaft 37 as the center and the pressure pushes up the swing piece 36 in the direction of an arrow “e” with the rotation shaft 37 as the fulcrum. Simultaneously, the pressure is applied to the force sensor 39. Thus, in this preferred embodiment, the force sensor 39 outputs detected pressure information as an electric signal, and the angle sensor 40 outputs the detected amount of displacement as an electric signal.

In this preferred embodiment, if either of them exceeds the threshold, it is detected that there is a possibility that the recording medium 9 may touch the recording head.

For example, if the recording medium 9 is thin, the threshold of the angle sensor 40 is set low. However, since in that case there is a possibility that the elastic center may curve concave upward, the threshold of the force of sensor 39 is set high. If the recording medium 9 is thick, the threshold of the angle sensor 40 is set high. However, since there is a possibility that each end in the width direction of the recording medium 9 which can be corrected by fairly weak force may bend, the force sensor 39 is set low. Thus, the collision can be accurately detected.

In this way, by detecting collision by combining the measurement values of both the rotation angle and the rotation torque, collision can be detected more precisely than in the first and second preferred embodiments.

Alternatively, it can be determined that if not only either of the outputs of both the force sensor 39 and the angle sensor 40, but also both of them exceed the thresholds, there is the possibility of the collision.

As described above, according to this preferred embodiment, a plurality of the combination can be possible using the type and bent shape of the recording medium 9, thereby realizing more precise collision detection.

Next, the fourth preferred embodiment of the present invention is described.

In the description of the fourth preferred embodiment, the same reference numerals are attached to the same components as in the first through third preferred embodiments, and the description of the same function or effect as in the first through third preferred embodiments is omitted here.

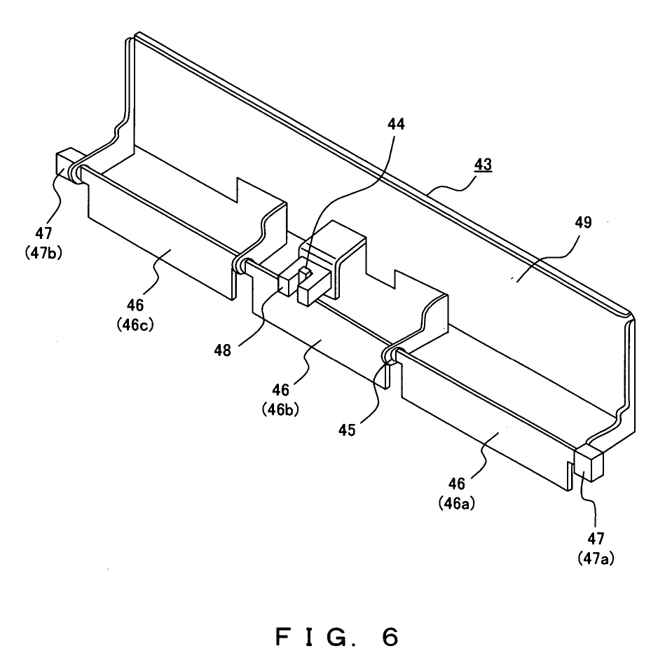

FIG. 6 shows the structure of the collision detection mechanism 43 in this preferred embodiment. The collision detection mechanism 43 comprises a swing piece 44 only for a lift-up detection member 46 at the center, a plurality of lift-up detection members 46 (46a, 46b and 46c) each for independently performing a pendulum movement with a rotation shaft 45 as the center, force sensors 47 (47a and 47b) for measuring the amount of force caused when the recording medium 9 collides with the lift-up detection members 46 (46a and 46c), an angle sensor 48 for measuring a rotation angle caused when the recording medium 9 collides with the lift-up detection member 46 (46b) and a holding member 49 for holding them.

In FIG. 6, the force sensors 47a and 47b are disposed in accordance with the lift-up detection members 46a and 46c at each end, and the angle sensor 48 is provided in accordance with the lift-up detection member 46b at the center. However, the force sensors 47 and the angle sensor 48 can also be provided for all the lift-up detection members 46 (46a, 46b and 46c).

In this preferred embodiment, a detection method can be selected depending on a part which the tip of the recording medium 9 touches. For example, if each end of the recording medium 9 is easy to bend and the center easily becomes concave upward, according to this preferred embodiment, the angle sensor 48 measures the change amount of an angle so that the lift-up detection member 46b detects a shape with the center concave. Then, if it exceeds the set threshold, it is determined that there is the possibility of the collision to stop the carrying of the recording medium 9.

However, the force sensors 47a and 47b measures the amount of force caused when the recording medium 9 touches the lift-up detection members 46a and 46c so that they detect a bent shape. Then, if it exceeds the set threshold, the carrying of the recording medium 9 is stopped.

Thus, even when a shape with the center concave upward and a bent shape mix in the recording medium 9, a recording medium 9 which may touch the recording head 16 can be accurately detected. If the force sensor 47 and the angle sensor 48 are provided for all the lift-up detection members 46 (46a, 46b and 46c), different thresholds can also be set for the center and each end.

Although in the first through fourth preferred embodiments, the example of the ink-jet printer 1 is described, the present invention is also applicable to an image recording device other than the ink-jet printer 1. For the force sensors 47a and 47b and the angle sensor 48, variously-structured sensors can be used.

Although for the carrying device of the recording medium 9, the platen unit 3 with the platen belt 11 for absorbing the recording medium 9 by negative pressure is used, the recording medium 9 can also be absorbed by static electricity. A rotating drum can also be used.

As described above, according to the above-described first through fourth preferred embodiments, by using a force sensor, it can be detected that a recording medium collides with a recording head and the damage of the recording head can be prevented.

By setting a plurality of thresholds depending on the type and lift-up status of a recording medium and adopting a threshold corresponding to the type and lift-up status of the recording medium, the collision can be optimally detected and the damage of a recording head can be prevented more surely.

Furthermore, by using an angle sensor and adopting a threshold corresponding to the type and lift-up status of the recording medium, the collision can be optimally detected and the damage of a recording head can be prevented more surely.

Next, the fifth preferred embodiment of the present invention is described.

In the description of the fifth preferred embodiment, the same reference numerals are attached to the same components as in the first through fourth preferred embodiments, and the description of the same function or effect as in the first through fourth preferred embodiments is omitted here.

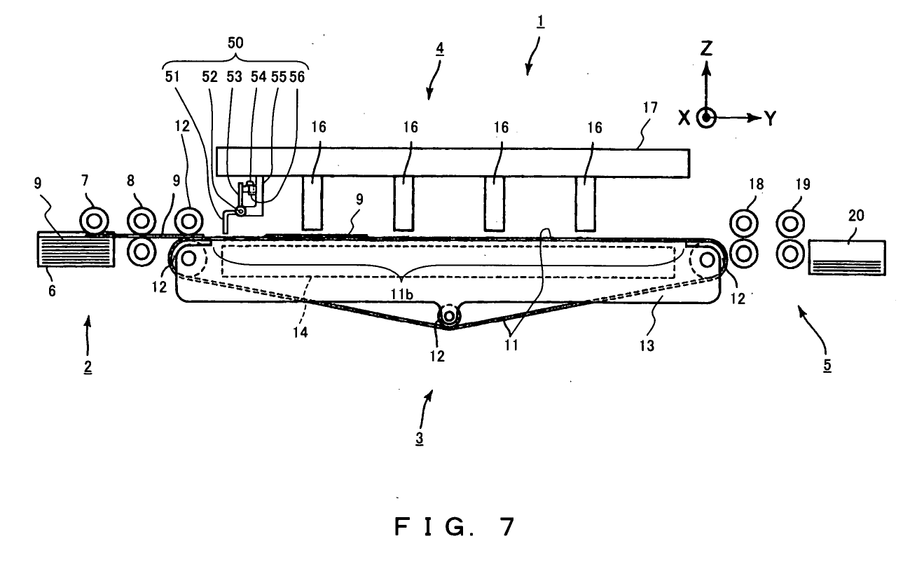

FIG. 7 is a side view typically showing the structure of the major part of the image forming apparatus in this preferred embodiment. As in FIG. 1, the image forming apparatus 1 comprises a paper feeding unit 2, a platen unit 3, am image recording unit 4 and a recording medium discharge unit 5. In FIG. 7 too, a direction along the carrying direction of the recording medium 9 is the Y-axis, a direction orthogonal to the Y-axis on a plane on which the image of the recording medium 9 is formed at the time of image recording is the X-axis and a direction orthogonal to the X- and Y-axes is the Z-axis.

Here, as one of this preferred embodiment, a collision detection mechanism 50 is provided between the paper feeding unit 2 and the image recording unit 4. The collision detection mechanism 50 comprises a recording medium lift-up detection member 51, a rotation shaft 52, a rotation transmission unit 53, a swing piece 54, a holding member 55 and a detection sensor 56.

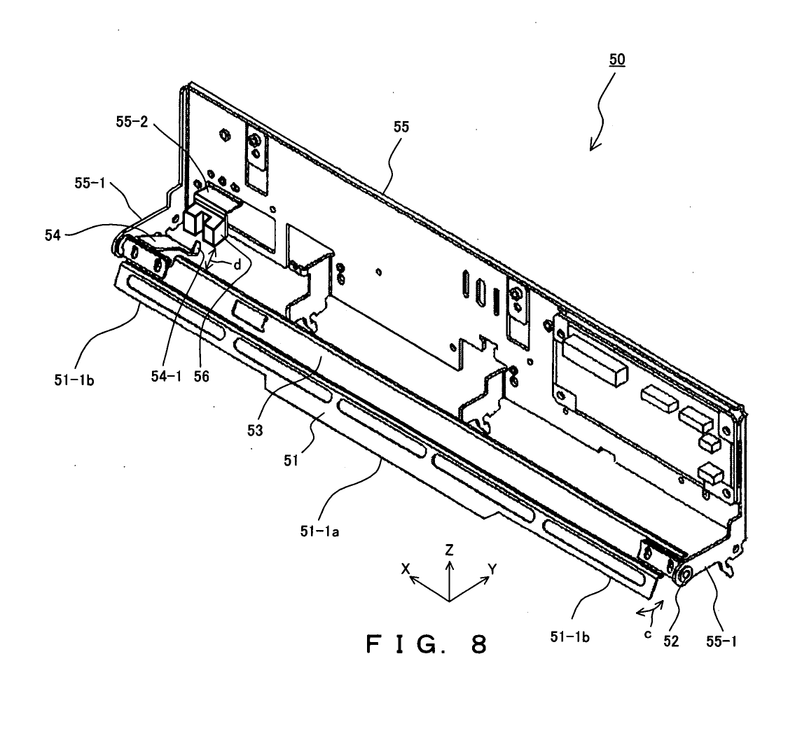

FIG. 8 is the detailed angular perspective of the collision detection mechanism 50 of the image forming apparatus 1 in this preferred embodiment. As shown in FIG. 8, the top end of the holding member 55 is fixed the carriage 17 (see FIG. 7), which is not shown in FIG. 8. The holding member 55 has an almost perpendicularly-projected support arm 55-1 at each end, and the recording medium lift-up detection member 51 and the rotation transmission unit 53 are supported via the rotation shaft 52 in such a way as to freely rotate at the tip of the support arm 55-1.

The recording medium lift-up detection member 51 and the rotation transmission unit 53 are incorporated. The recording medium lift-up detection member 51 is disposed perpendicular to the carrying direction (Y-axis direction)(Z-axis direction) and is extended in the width direction of the recording medium 9 (X-axis direction).

The swing piece 54 is mounted almost perpendicular to one end (left end in FIG. 8) of the rotation transmission unit 53. A swing nail 54-1 which is formed by almost perpendicularly folding the sideway extended slender part of the swing piece 54 is disposed in this swing piece 54.

When recording medium lift-up detection member 51 rotates like a pendulum in the Y-axis direction as indicated by a two-way arrow “c” in FIG. 8, with the rotation shaft 52 as the fulcrum, the rotation is transmitted to the swing piece 54 via the rotation transmission unit 53 to rotate the swing piece 54 and the swing nail 54-1 of this swing piece 54 rotates like a pendulum (pendulum movement) in the Z-axis direction as indicated by an arrow “d”.

The detection sensor 56 is disposed in the pendulum movement position of this swing nail 54-1. The detection sensor 56 is a transmission type photo-sensor and is fixed and provided for a cutting-off/folded part 55-2 of the holding member 55. The detection sensor 56 is switched on/off by the pendulum movement of the swing nail 54-1, and its detection output is transmitted to the platen unit drive/control unit, which is not shown in FIG. 8, via a wiring, which is also not shown in FIG. 8.

In the structure of the collision detection mechanism 50, if the recording medium 9 is shaped in such a way as to collide with a printing head 16, the collision detection mechanism 50 detects the collision before the recording medium 9 is carried to under the printing head 16.

When the detection mechanism 50 detects the collision, a detection signal is outputted from the detection sensor 56 and is transmitted to the platen unit drive/control unit. The platen unit drive/control unit, for example, stops the drive of the belt roller driving motor 12a to prevent the recording medium 9 from colliding with the printing head 16.

One method for detecting the recording medium in such a shape as to collide with the printing head 16 is to measure the space between the printing head 16 and the platen belt 11 to clarify the thickness t2 of an object which is anticipated to collide with the printing head 16.

Then, the distance t1 between the recording medium lift-up detection member 51 and the platen belt 11 in such a way that when the recording medium 9 with thickness t1 attempts to pass through under the collision detection mechanism 50, it can touch the recording medium lift-up detection member 51 to swing the swing piece 54 via the recording medium lift-up detection member 51 and the rotation transmission unit 53 and to switch on/off the detection sensor 56 by the pendulum movement of the swing piece 54.

Thus, when the recording medium 9 with thickness t2 attempts to pass through under the collision detection mechanism 50, the recording medium lift-up detection member 51 touches the recording medium 9 and rotates (or swings) to swing the rotation transmission unit 53 and the swing piece 54. Then, the detection sensor 56 detects the pendulum movement of the swing piece 54 and transmits the detection signal to the platen unit drive/control unit to stop the drive of the belt roller driving motor 12a. Thus, the recording medium 9 can be prevented from colliding with the printing head 16.

Although in the above description, the thickness t2 of the recording medium 9 is detected, this thickness t2 is not actually the thickness of the recording medium 9 itself, but it includes the height of its lift-up from the platen belt 11 surface.

FIGS. 9A, 9B and 9C show various typical shapes of the recording medium which cause the recording medium 9 to lift-up off the platen belt 11 surface.

As shown in FIG. 9, the recording media 9 (9-1, 9-2 and 9-3) take various peculiar shapes, such as a shape with its each end bent upward like the recording medium 9-1 (FIG. 9A), a shape with the center concave like the recording medium 9-2 (FIG. 9B), a combined shape of bent upward at each end and concaveness at the center like the recording medium 9-3 (FIG. 9C) and the like on a plane perpendicular to the recording medium carrying direction (Y-axis direction), depending the type, storage environment and the like of the recording medium 9.

The thickness t2 of the recording medium 9 are the height p and p′ from the platen belt 11 surface of the part with each end bent upward, the height q from the platen belt 11 surface of the part with the center concave upward, the height r, r′ and r″ from the platen belt 11 surface of the part with each end bent upward and the center concave upward and the like.

### The First Preferred Embodiment

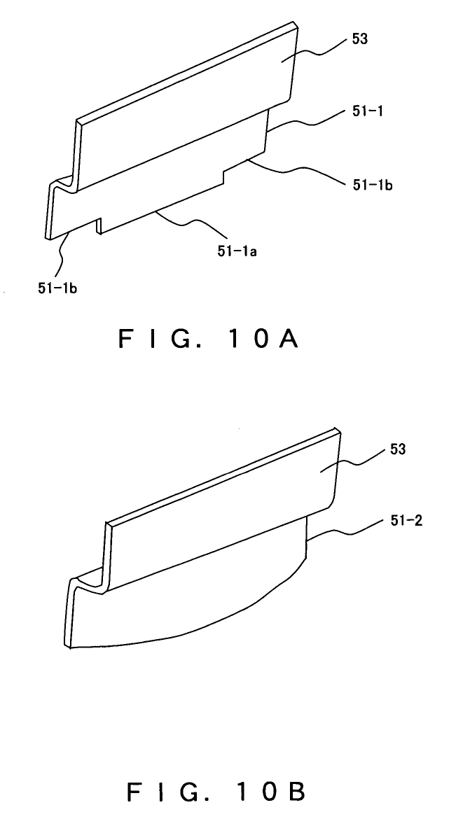

FIG. 10 shows the detailed shape of the recording medium lift-up detection member 51 in the first preferred embodiment of the collision detection mechanism 50. FIGS. 10A and 10B show two types of recording medium lift-up detection members with different shapes 51-1 and 51-2.

In this preferred embodiment, the shape of the end surfaces opposing the recording medium 9 of the recording medium lift-up detection members 51 (51-1 and 51-2), which are not shown in FIG. 10, is made convex and concave according to the lift-up shape of the recording media 9 (9-1, 9-2 and 9-3) to detect, and the detection is made in accordance with the lift-up shape of the recording medium 9.

For example, if the recording medium 9 floats like the recording medium 9-3 as shown in FIG. 9C, the recording medium lift-up detection member 51-1 shaped as shown in FIG. 10A is used. The bottom end surface opposing the recording medium 9 of this recording medium lift-up detection member 51-1 is divided into three of a bottom end surface 51-1a at the center and bottom end surfaces 51-1b at each end.

The space between the bottom end surface at the center 51-1a and the recording medium 9/the platen belt 11 is not uniform and different in the width direction of the recording medium 9 and has two space values. The bottom end surface at the center 51-1a is shaped concave at a different level between the bottom end surfaces 51-1b at each end in such a way that the space between the bottom end surface at the center 51-1a and the recording medium 9/the platen belt 11 may become narrower than the space between the bottom end surfaces 51-1b at each end and the recording medium 9/the platen belt 11.

Thus, the sensitivity to detect the lift-up of the recording medium 9 by the bottom end surface at the center 51-1a of the recording medium lift-up detection member 51-1 can be made higher than the sensitivity to detect the lift-up of the recording medium 9 by the bottom end surfaces at each end 51-1b. In other words, the height of the bend at each end of the recording medium 9-3 and the height of wave-shaped concaveness at the center can be detected at different detection levels.

However, the lift-up height of the recording medium that is anticipated to collide with the printing head 16 varies depending on the type of the curling tendency of the recording medium 9, such as bend and wave-shaped concaveness.

For example, since the height of the curling tendency of bend at which the recording medium 9 starts colliding with the printing head 16 is higher than that of wave-shaped concaveness, the recording medium 9 in a dangerous status can be correctly detected without sensitively detecting a printable recording medium 9 or conversely without failing to detect a recording medium 9 that is anticipated to collide with the printing head 16, by using the shape of the recording medium lift-up detection member 51-1 shown in FIG. 10A.

Although the shape of the recording medium detection end surface of the recording medium lift-up detection member 51-1 shown in FIG. 10A has one difference level, it can also have a plurality of different levels and three or more different level values instead of two. As shown in FIG. 10B, the shape of the recording medium detection end surface can also continuously change to become an almost circular arc with the center concave or the like, and the space between the bottom end of the recording medium lift-up detection member 51-2, the recording medium 9 cannot also be uniform in the width direction of the recording medium 9 and its space values can also be a curve with continuous innumerable values.

As described above, the shape of the recording medium detection end surface of the lift-up detection member 51 can be properly determined according to the type and lift-up status of a recording medium 9 to be used.

For example, if the influence of the lift-up at the center of the recording medium 9 is less than that at its end, the center of the recording medium detection end surface can be made convex instead of the shape of the recording medium lift-up detection member 51-1 shown in FIG. 10A. The recording medium detection end surface can also be divided into two or more areas instead of three ones.

The shape that continuously changes like the recording medium lift-up detection member 51-2 shown in FIG. 10 cannot also be limited to a circular arc and it can also be a complex curve. Alternatively, it can be obtained by combining the circular arc shown in FIG. 10B with the shape with a different level shown in FIG. 10B.

### The Second Preferred Embodiment

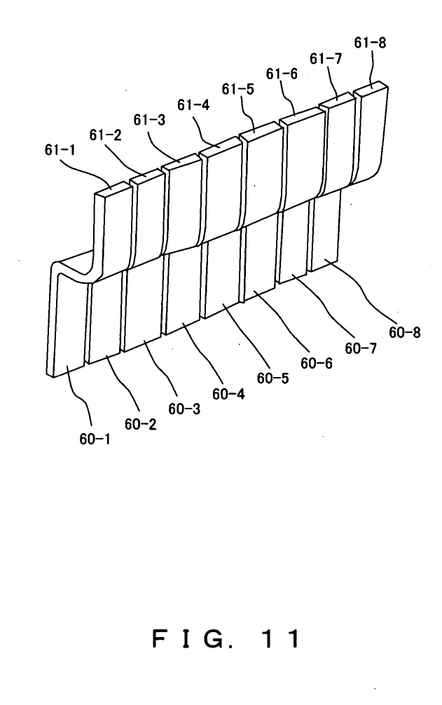

FIG. 11 shows the detailed shapes of the recording medium lift-up detection member in the second preferred embodiment and the fourth preferred embodiment described later of the collision detection mechanism 50.

In this preferred embodiment, as shown in FIG. 11, the recording medium lift-up detection member of the collision detection mechanism 50 is divided into a plurality of parts. In FIG. 11, the FIG. 11 shows the detailed shapes of the recording medium lift-up detection member in the second and fourth preferred embodiments of the collision detection mechanism of this preferred embodiment is divided into eight recording medium lift-up detection members 60 (60-1, 60-2, 60-3, 60-4, 60-5, 60-6, 60-7 and 60-8).

A detection transmission piece incorporated into these eight recording medium lift-up detection members is also divided into eight detection transmission pieces 61 (61-1, 61-2, 61-3, 61-4, 61-5, 61-6, 61-7 and 61-8).

The respective detection sensitivity of the recording medium lift-up detection members 60 (60-1, 60-2, 60-3, 60-4, 60-5, 60-6, 60-7 and 60-8) is not the same and is adjusted non-uniformly in such a way as to have at least two pieces of detection sensitivity.

In order to adjust the detection sensitivity of each recording medium lift-up detection member 60, the space t1 between the recording medium lift-up detection member 60 and the platen belt 11, which is described with reference to FIG. 8, of a part whose sensitivity is desired to be sensitive is made narrower than those of the other parts.

Conversely the space t1 between the recording medium lift-up detection member 60 and the platen belt 11 of a part whose sensitivity is desired to be insensitive is made wider than that of other parts.

As another method, the detection sensor 56 is switched on/off in such a way that the swing width in the pendulum movement of the swing piece 54 of the recording medium lift-up detection member 60 of a part whose sensitivity is desired to be sensitive (see FIGS. 7 and 8) is narrower than the swing widths of the other parts.

Conversely the detection sensitivity can be made insensitive by switching on/off the detection sensor 56 in such a way that the swing width in the pendulum movement of the swing piece 54 of the recording medium lift-up detection member 60 of a part whose sensitivity is desired to be insensitive is wider than the swing widths of the other parts.

If the detection sensitivity is made sensitive or insensitive, the detection sensitivity can be easily adjusted by vertically or horizontally moving the disposed position of the detection sensor 56 against the recording medium lift-up detection member 60 in accordance with the relationship between the swing width in the pendulum movement of the swing piece 54.

For example, if the recording medium 9-3 with a combined shape of each bent end and the concave center shown in the lower section of FIG. 9 is desired to positively detect, it is adjusted in such a way that the respective detection sensitivity of the recording medium lift-up detection members 60-3, 60-4, 60-5 and 60-6 at the center shown in FIG. 11 is more sensitive than those of the recording medium lift-up detection members 60-1, 60-2, 60-7 and 60-8 at each end.

If the recording medium 9-1 with a shape with each bent end shown in FIG. 9A is desired to positively detect, it is adjusted in such a way that the respective detection sensitivity of the recording medium lift-up detection members 60-1, 60-2, 60-7 and 60-8 at each end is more sensitive than those of the recording medium lift-up detection members 60-3, 60-4, 60-5 and 60-6 at the center.

As described above, according to the recording medium lift-up detection member 60, the detection can be performed according to the lift-up shape of a recording medium 9 to detect.

By setting the length (period) of the on/off time of the detection sensor 56 according to a detection purpose, such as a desire to detect even the slight lift-up of the recording medium 9, a desire to detect only wide floats, a desire to detect only long-formed lift-up and the like, the sensitivity of the recording medium lift-up detection member 60 can be adjusted and shape abnormality to detect of the recording medium 9 can be arbitrarily detected.

### The Third Preferred Embodiment

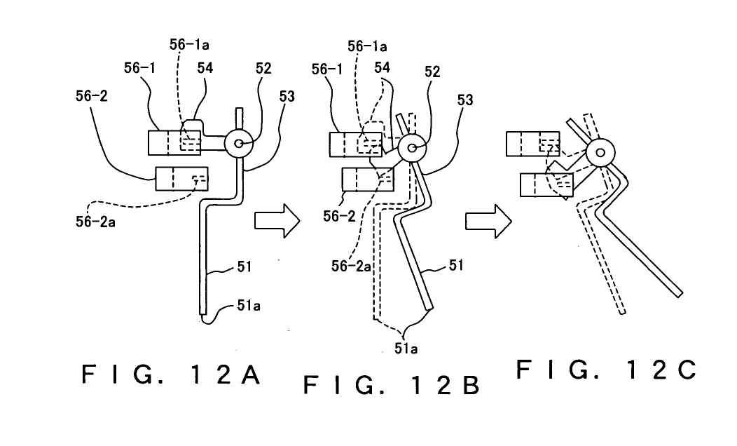

FIG. 12 (FIGS. 12A 12B 12c) shows the detailed shape of the recording medium lift-up detection member in the third preferred embodiment of the collision detection mechanism and its operation.

Although the mounting position of the swing piece 54 incorporated into the rotation transmission unit 53 against the recording medium lift-up detection member 51, rotation shaft 52 and rotation transmission unit 53 disposed in the collision detection mechanism 50 shown in FIG. 12 is the reverse of that in FIG. 7 for convenience' sake, the following function and operation of this preferred embodiment has no relation to the direction of the mounting position of this swing piece 54.

The structural relationship between the swing piece 54 and two detection sensors 56 in the collision detection mechanism 50 described below is also applicable to the first and second preferred embodiments shown in FIGS. 10 and 11, respectively, and to the fourth preferred embodiment described later.

As shown in FIG. 12C, in the collision detection mechanism 50 of this preferred embodiment, two detection sensors 56 (56-1 and 56-2) are provided for the swing piece 54.

Even in the case of the recording medium lift-up detection member 51 with this structure, if the bottom end surface 51a closely touches the shape abnormality of the recording medium 9, which is not shown in FIG. 12, all the recording medium lift-up detection member 51, the rotation transmission unit 53 and the swing piece 54 rotate counter-clockwise with the rotation shaft 52 as the fulcrum as shown in FIG. 12B.

Then, following this rotation, the swing piece 54 rotates from a position corresponding to the upper detection sensor 56-1 toward the lower detection sensor 56-2. By such a structure, the detection can be performed according to the quality of the recording medium 9, such as hardness, elasticity, shape and the like. For example, if the lift-up part of the recording medium 9 touches the bottom end surface 51a of the recording medium lift-up detection member 51 when the recording medium 9 is hard, the recording medium lift-up the detection member 51 swings greatly. The swing piece 54 also swings greatly according as the swing amount of the recording medium lift-up detection member 51.

In this case, a hard recording medium 9 can be separately detected by disposing the switches 56-1a and 56-2a of the detection sensors 56 (56-1 and 56-2, respectively) in places matched with the swing width of the swing piece 54.

If the lift-up part of the recording medium 9 touches the bottom end surface 51a of the recording medium lift-up detection member 51 when the recording medium 9 is soft, the recording medium 9 yields to the respective weight of the recording medium lift-up detection member 51 and rotation transmission unit 53 and the resistance of the bottom end surface 51a of the recording medium lift-up detection member 51 and the shape of the lift-up part of the recording medium 9 changes. In this case, since the recording medium lift-up detection member 51 cannot be swung greatly, the swing piece 54 also swings slightly.

Thus, a soft recording medium 9 can be separately detected by disposing the detection sensor 56-1 in such a way that the switch 56-1a of the detection sensor 56-1 is located in a place matched with the swing width of the swing piece 54 that swings slightly.

As described above, according to this preferred embodiment, the detection can be performed according to the detailed lift-up shape of the recording medium 9.

In FIG. 12A, the recording medium lift-up detection member 51 cannot detect the recording medium 9, and the switch 56-1a of the detection sensor 56-1 is turned on and the switch 56-2a of the detection sensor 56-2 is turned off.

In FIG. 12B, the recording medium lift-up detection member 51 is detecting, for example, a soft recording medium 9 (or has just started detecting shape abnormality) and the swing width of the swing piece 54 is narrow. In this case, the swing piece 54 is located in the middle of the switch 56-1a of the detection sensor 56-1 and the switch 56-2a of the detection sensor 56-2, and the switches 56-1a and 56-2a of the detection sensors 56-1 and 56-2 both are turned off.

In FIG. 12C, the recording medium lift-up detection member 51 is detecting, for example, a hard recording medium 9 (or has just started detecting great shape abnormality) and the swing width of the swing piece 54 is wide. In this case, the swing piece 54 is located out of the position of the detection sensor 56-1 and rotates up to the position of the detection sensor 56-2. Thus, the switch 56-1a of the detection sensor 56-1 is turned off and the switch 56-2a of the detection sensor 56-2 is turned on.

In this way, since three types of output combinations can be obtained using two detection sensors, which detection sensor should be used to detect the recording medium 9 can be determined by selecting the type of a recording medium 9 to use by an operator's input from an operation panel, which is not shown in FIG. 12 and performing the detection by a detection sensor matched with the selected recording medium 9 as described above.

As shown in FIG. 12, the number of the detection sensors 56 is not limited to two, and the lift-up shapes of many types of recording media 9 can be detected by providing the number of detection sensors matched with a recording medium 9 to detect.

As to a collision detection mechanism 50 not using a plurality of detection sensors 56, adjustment must be applied to it for each recording medium 9 before installing it in the image forming apparatus 1. After the installation, the collision detection mechanism 50 must be used in the adjustment status. However, if a plurality of detection sensors 56 is used as described above, the lift-up shapes of many types of recording media 9 can be detected only by selecting a recording medium 9 to use from the operation panel without removing the collision detection mechanism 50 from the image forming apparatus and re-adjusting it.

If a sensor capable of analogically outputting the swing width of the swing piece 54 is used for the detection sensor 56, its detection sensitivity can be changed by changing the detection level of the output value of one detection sensor. In this case, the detection level can be freely controlled at an arbitrary time from the controller of the image forming apparatus 1, thereby freely corresponding to various recording media 9 and floats.

### The Fourth Preferred Embodiment

Although in the structure shown in FIG. 11, a method for simply detecting the recording medium 9 according to its lift-up shape is described, in this preferred embodiment, the detection method of the lift-up shape of the recording medium 9 in the case where the dimension of the width perpendicular to the carrying direction of the recording medium 9 is smaller than those of the array width direction of the recording medium lift-up detection member 60 is described.

As an example of the case where the dimension of the width direction against the carrying direction of the recording medium 9 is a half of those of the array width direction of the recording medium lift-up detection member 60 is described in order to make the description easily understood.

Firstly, the detection of the lift-up shape of the recording medium 9 in the case where the recording medium 9 is carried after aligning the center of the carrying width direction of the recording medium 9 to the center of the carrying width direction of the platen unit 3 is described.

In this case, when an operator sets the shape of the recording medium 9 by input from the operation panel, which is not shown in FIG. 11, four recording medium lift-up detection members 60-3, 60-4, 60-5 and 60-6 detect the recording medium 9.

As described above, if, for example, the shape of the recording medium 9 to positively detect is bent upward at each center like the recording medium 9-1 shown in the upper section of FIG. 9 when the dimension in the carrying width direction of the recording medium 9 is a half, in the structure shown in FIG. 11, desired detection can be possible by adjusting in such a way that the recording medium lift-up detection members 60-3 and 60-6 are more sensitive than the others.

Only a restricted point, for example, only the concave center, of the recording medium 9, can also be detected if the operator sets to use only the detection sensor of a part to detect, from the operation panel, which is not shown in FIG. 11.

Next, the detection of the lift-up shape of the recording medium 9 in the case where the recording medium 9 is located on the end of the platen unit 3 and is carried, in other words, the recording medium 9 is carried after aligning one end of the carrying width direction of the recording medium 9 (for example, the right side end when facing the lower stream side of the carrying direction) to one end of the carrying width direction of the platen unit 3 (for example, the right side end when facing the lower stream side of the carrying direction) is described.

Firstly, in this case too, the carrying method of the recording medium 9 and the width dimension perpendicular to the carrying direction of the recording medium 9 are set from the operation panel, which is not shown in FIG. 12. Thus, if the dimension of the recording medium 9 is a half of the array width direction dimension of the recording medium lift-up detection member 60 as described above, it is adjusted in such a way that the detection is performed by four recording medium lift-up detection members 60-1, 60-2, 60-3 and 60-4.

Next, if apart, the lift-up shape of the recording medium 9 to detect in which is desired to detect sensitively, for example, the lift-up of the center is desired to detect, the respective detection sensitivity of the recording medium lift-up members 60-2 and 60-3 is set in such a way as to be sensitive, by input from the operation panel.

As described above, even when the carrying method of the recording medium 9 with a small width dimension is the center alignment or the end alignment, or further there is a plurality of shapes in the recording medium 9, the lift-up shape of the recording medium 9 can be detected only by the setting of the operation panel.

As described in detail so far, according to the present invention, the lift-up shape of the recording medium 9 from a prescribed position, such as a platen surface, can be detected according to the type and lift-up shape of the recording medium 9, and a lift-up shape in danger of collision can be detected before the recording medium 9 collides with the printing head, thereby preventing the printing head from being damaged.

As shown in each preferred embodiment, according to the present invention, since the recording medium lift-up detection member is structured in such a way that the lift-up detection sensitivity of the recording medium varies depending on the width direction, the lift-up of the recording medium which may incur the damage of the printing head when it collides with the printing head cannot be wrongly detected and can be surely detected, regardless of the lift-up shape from the recording medium carrying mechanism and type of the recording medium.

What is claimed is:

1. An image forming apparatus, comprising:
a recording medium carrying mechanism for carrying a recording medium;
a recording head fixed on a device main body, for recording an image on the recording medium carried by the recording medium carrying mechanism;
a recording medium lift-up sensor disposed in a upper stream of a carrying direction of the recording medium than the recording head; and
a carrying control unit for controlling the recording medium carrying mechanism based on the detection output of the recording medium lift-up sensor, wherein
the recording medium lift-up sensor comprises
a recording medium lift-up detection member for sensing a lift-up part of the recording medium; and
a force sensor for detecting a amount of force of the recording medium which acts on the recording medium lift-up detection member.

2. The image forming apparatus according to claim 1,
wherein
the force sensor outputs the amount of force in multiple values.

3. The image forming apparatus according to claim 2, wherein
the carrying control unit has a plurality of different force amount thresholds corresponding to a type of the recording medium, and controls the recording medium carrying mechanism, based on the detection output of the recording medium lift-up sensor.

4. The image forming apparatus according to claim 3, wherein
a plurality of the recording medium lift-up detection members is disposed along a direction orthogonal to the recording medium carrying direction.

5. The image forming apparatus according to claim 4, wherein
the recording medium lift-up detection members are disposed at a center in a width direction of a recording medium carried by the recording medium carrying mechanism and at each ends in the width direction.

6. The image forming apparatus according to claim 5, wherein
the carrying control unit has different thresholds at the center and each the ends.

7. An image forming apparatus, comprising:
a recording medium carrying mechanism for carrying a recording medium;
a recording head fixed on a device main body, for recording an image on the recording medium carried by the recording medium carrying mechanism;
a recording medium lift-up sensor disposed in a upper stream of a carrying direction of the recording medium than the recording head; and
a carrying control unit for controlling the recording medium carrying mechanism based on the detection output of the recording medium lift-up sensor, wherein
the recording medium lift-up sensor comprises
a swing piece for sensing the lift-up part of the recording medium; and
an angle sensor for detecting the amount of swing of the swing piece.

8. The image forming apparatus according to claim 7,
wherein
the angle sensor outputs a level of the amount of swing in multiple values.

9. The image forming apparatus according to claim 8, wherein
the carrying control unit has a plurality of thresholds of the amount of swing corresponding to a type of the recording medium, and controls the recording medium carrying mechanism, based on the threshold of the amount of swing corresponding to the recording medium to use and a detection output of the recording medium lift-up sensor.

10. The image forming apparatus according to claim 9, wherein
a plurality of the swing piece is disposed along a direction orthogonal to the recording medium carrying direction.

11. The image forming apparatus according to claim 10, wherein
the swing pieces are disposed at a center in a width direction of a recording medium carried by the recording medium carrying mechanism and at each end in the width direction.

12. The image forming apparatus according to claim 11, wherein
the carrying control unit has different thresholds at the center and at each end.

13. An image forming apparatus, comprising:
a recording medium carrying mechanism for carrying a recording medium;
a recording head fixed on a device main body, for recording an image on the recording medium carried by the recording medium carrying mechanism;
a recording medium lift-up sensor disposed in a upper stream of a carrying direction of the recording medium than the recording head; and
a carrying control unit for controlling the recording medium carrying mechanism based on the detection output of the recording medium lift-up sensor, wherein
the recording medium lift-up sensor comprises
a swing piece for sensing the lift-up part of the recording medium;
an angle sensor for detecting the amount of swing of the swing piece; and
a force sensor for detecting an amount of force of the recording medium which acts on the swing piece.

14. The image forming apparatus according to claim 13,
wherein
the angle sensor and the force sensor output respective levels of the amount of swing and the amount of force in multiple values.

15. The image forming apparatus according to claim 14, wherein
the carrying control unit has a plurality of thresholds of the amount of swing corresponding to a type of the recording medium and a plurality of thresholds of the amount of force corresponding to the type of the recording medium, and controls the recording medium carrying mechanism, based on the threshold of the amount of swing and the threshold of the amount of force, corresponding to the recording medium to use, and a detection output of each sensor of the recording medium lift-up sensors.

16. The image forming apparatus according to claim 15, wherein
a plurality of the swing piece is disposed along a direction orthogonal to the recording medium carrying direction.

17. The image forming apparatus according to claim 16, wherein
the swing pieces are disposed at a center in a width direction of a recording medium carried by the recording medium carrying mechanism and at each end in the width direction.

18. The image forming apparatus according to claim 17, wherein
the carrying control unit has different thresholds at the center and at each end.

19. The image forming apparatus according to claim 15,
wherein
when the detection output of either of the angle sensor or the force sensor exceeds either of the thresholds, the carrying control unit stops carrying of the recording medium by the recording medium carrying mechanism.

20. The image forming apparatus according to claim 15,
wherein
when respective detection outputs of the recording medium lift-up sensors exceed the respective thresholds, the carrying control unit stops carrying of the recording medium by the recording medium carrying mechanism.

21. The image forming apparatus according to claim 7, wherein
a tip of the swing piece protrudes toward the recording medium side further than a tip of the recording head.

22. The image forming apparatus according to claim 13, wherein
a tip of the swing piece protrudes toward the recording medium side further than a tip of the recording head.

23. The image forming apparatus according to claim 1, wherein
a tip of the recording medium lift-up detection member protrudes toward the recording medium side further than a tip of the recording head.

24. The image forming apparatus according to claim 7 wherein
the recording head is an ink-jet head.

25. The image forming apparatus according to claim 13, wherein
the recording head is an ink-jet head.

26. An image forming apparatus, comprising:
a recording medium carrying mechanism for carrying a recording medium;
a recording head fixed on a device main body, for recording an image on the recording medium carried by the recording medium carrying mechanism; and
a collision alarm sensor located in an upper stream in a carrying direction of the recording medium by the recording medium carrying mechanism than the recording head,
wherein
the collision alarm sensor comprises
a recording medium lift-up detection member for detecting a lift-up part of the recording medium; and
a detection sensor for detecting a status change of the recording medium lift-up member,
the recording medium lift-up detection member extends perpendicular to a carrying direction of the recording medium and also in a width direction of the recording medium, and has at least two values in the width direction as sensitivity for sensing a lift-up of the recording medium.

27. The image forming apparatus according to claim 26, wherein
the recording head is an ink-jet head.

28. The image forming apparatus according to claim 26, wherein
a plurality of detection sensors is provided.

29. The image forming apparatus according to claim 26, wherein
the recording medium lift-up detection member has at least two values in the width direction as space with the recording medium.

30. The image forming apparatus according to claim 29, wherein
space between the recording medium lift-up detection member and the recording medium at a center in the width direction is narrower than space the recording medium lift-up detection member and the recording medium at an end in the width direction.

31. The image forming apparatus according to claim 26, wherein
the recording medium lift-up detection member is divided into a plurality of members.

32. The image forming apparatus according to claim 31, wherein
the recording medium lift-up detection member has at least two values as space with the recording medium.

33. The image forming apparatus according to claim 31, wherein
the recording medium lift-up detection member has at least two values as detection sensitivity of the recording medium.

34. The image forming apparatus according to claim 31, wherein
the recording medium lift-up detection member has at least two values as detection swing angle of the recording medium.
